(19) United States
(12) Patent Application Publication
(10) Pub. No.: US 2019/0314122 A1
(43) Pub. Date: Oct. 17, 2019

(54) DENTAL INSERT FOR CONNECTING A DENTAL IMPLANT TO A DENTAL ABUTMENT

(71) Applicant: UNIVERSITÄT BASEL, Basel (CH)

(72) Inventors: Stefan STÜBINGER, Binningen (CH); Markus LINK, Muttenz (CH)

(21) Appl. No.: 16/472,526

(22) PCT Filed: Dec. 20, 2017
(86) PCT No.: PCT/EP2017/083939

§ 371 Date: Jun. 21, 2019

(30) Foreign Application Priority Data
Dec. 23, 2016 (EP) 16206721.9

(51) Int. Cl. A61C 8/00

(52) U.S. Cl. CPC A61C 8/0062; A61C 8/0063; A61C 8/0068; A61C 8/0054; A61C 8/0065

(57) ABSTRACT

A dental insert for connecting a dental implant to a dental abutment includes a dental abutment having at least two interfaces. A first interface of the at least two interfaces is formed in interaction with the abutment for fixing the dental insert to the implant by a latching and/or clamping connection. A second interface of the at least two interfaces is formed for fixing the dental insert to the dental abutment.

### BACKGROUND AND SUMMARY OF THE INVENTION

Exemplary embodiments of the present invention concern a dental insert for connecting a dental implant to a dental abutment, and an arrangement of the dental insert with the dental abutment and a dental prosthesis.

JP 2011 120 723 A discloses a three-piece denture with an implant. The implant has a terminal pin on which a sleeve-shaped clamping device is placed. It is an attachment because the clamping agent does not protrude into the body of the implant. Finally, another dental abutment is placed on this sleeve-shaped attachment. On the one hand, the design has the disadvantage that lateral forces are only absorbed by the pin, which limits the choice of material. In the case of a ceramic implant, for example, there is a risk that the pin will break due to the unfavorable mechanical distribution of force.

US 2016/0206409 A1 discloses a multi-part implant unit having an implant in the form of a hollow cylindrical screw and having a dowel-like insert arranged in it and a dental abutment with a screw bolt. In this case, the connection between insert, abutment and implant is made by a screw connection.

US 2016/0354183 A1 discloses an implant unit having an implant of a sleeve that can be inserted in certain areas and a screw-on dental abutment.

Based on the aforementioned prior art, exemplary embodiments of the present invention are directed to achieving a connection between a dental implant and a dental abutment that is hygienic, and preferably biomechanically stable and form-fit, and which has only low mechanical loads and advantageous force distributions.

According to the invention, a dental insert is provided for connecting a dental implant to a dental abutment. A corresponding attachment can preferably be designed as a tooth crown or a so-called abutment. This dental application has at least two interfaces.

A first interface is formed in interaction with the abutment for fixing the dental insert to the implant by at least one latching and/or clamping connection.

This first interface can have, for example, a receptacle with latching noses or the like into which a projection of the implant can be inserted. The receptacle wall can then receive a material reinforcement by connecting the dental insert to the dental abutment so that the abutment is fixed positively to the implant by latching or clamping.

The second interface is designed for fixing the abutment. This can preferably be done by screwing. A screw connection and a screw channel in the sense of the present invention are among other things also bayonet connections, so that two elements are brought into engagement with each other by a rotary movement analogous to a conventional screw.

The dental insert is designed as an insertion cap with a cap opening, a cap base and a cap lateral surface. The cap base is not necessarily a closed surface but can have advantageous recesses. The cap base is the first of the at least two interfaces to have a receptacle with a receptacle space for insertion onto a projection of the implant.

The receptacle can advantageously have an area for receiving a projection thickening and an adjacent area with a cross-sectional narrowing of the receptacle.

The insertion cap can have a longitudinal axis, wherein the receptacle is advantageously centered on the longitudinal axis.

The receptacle preferably has a receptacle wall delimiting the receptacle space, wherein a cap space extends adjacent to the receptacle wall into which the attachment can be inserted in certain areas.

The receptacle wall can advantageously have a wall thickness of less than 1 mm so that a limited deformability of the receptacle wall can be ensured for introducing the projection into the receptacle space.

The insertion cap can also advantageously have a gap-shaped recess extending over at least some areas of the cap base and at least some areas of the cap sleeve. This recess is a type of material weakening and allows limited variability in the way the recess is opened to accommodate the implant protrusion.

The second of the at least two interfaces can be designed as a screw channel. A threaded or bayonet channel is to be understood as a screw channel in the sense of this invention.

Alternatively, the second interface can also be a pin-like projection. This can be inserted into a recess in the receptacle and cast, glued or latched into the recess. This results in an arrangement, which is referred to below as an arrangement in accordance with the invention.

For casting, a casting compound, preferably a hardenable casting compound, can be used advantageously. In the hardened state, the casting compound is particularly preferred to be less hard than the abutment, e.g., to allow the casting compound to be drilled out.

Alternatively, when the projection is latched, it can have an end latching element, e.g., an expansion head, which forms a positive connection with a stop surface of the abutment.

The receptacle wall can advantageously have projections that project into the receptacle space. These protrusions are designed to engage behind the protrusion thickening and allow strengthening the fixation of the protrusion and prevent the protrusion from moving along the axial direction of the longitudinal axis of the dental insert.

The insert may advantageously comprise at least 45% by weight, preferably at least 90% by weight of a polyether ketone. This type of material is suitable for hygienic use in moist oral environments and also has material properties with regard to material deformation, which have a positive effect on the flexibility of the opening width of the receptacle.

The dental insert is advantageous, in particular it is exchangeable with the abutment by loosening the positive connection and can be fixed in the implant.

The material of the dental insert may include at least one antibacterial, disinfectant and/or anti-inflammatory active substance that may be replaced at a regular check-up. Due to the interchangeability of the insert, the active ingredient can always be renewed. The dosage of the active ingredient in dentistry can be chosen according to the degree of the disease. Thus, there can be applications with no, low or high dosage of active substances, which can be selected according to requirements, e.g., degree of inflammation.

In addition, the dental insert has an edge protruding from the lateral surface of the cap in the radial direction to the longitudinal axis of the insertion cap and thus protects the area between the implant and the insert from contamination and the like.

The dental insert may comprise or consist of a swellable material. In this context, swellable means that when a liquid, in particular water and/or saliva, is absorbed, the volume increases by at least 2% by volume, preferably at least 5% by volume. This results in a sealing effect so that liquid (blood, saliva or the like) cannot penetrate into the deeper-lying area of the denture and rot there. Accordingly, this is associated with a lower odor development and a reduced risk of infection. In addition, the swelling of the material results in better biomechanical stabilization in receiving the implant.

An arrangement with an abutment and an insert according to the invention are also in accordance with the invention. These two elements can be combined to form a unit when used as intended or already during production at the manufacturer's plant or can be sold as combinable elements. For example, it is thus possible that the dental insert and the dental abutment are dimensioned in relation to each other. The elements of the arrangement may, however, be sold separately in one package before their intended use. This is also to be understood as an arrangement within the framework of the present invention.

The connection of both elements can be achieved by a mechanical connecting means. However, it is also possible to achieve a latching connection between the abutment and the insert by means of separate or integrally formed latching elements, which can be drilled out or removed when replacing the dental abutment and the dental insert.

The abutment has a ring-shaped end section that can be positioned in the cap space. An annular end section is in particular also a ring which has interruptions and arcuate ring segments which preferably lie on a common ring plane.

For optimum material reinforcement and to avoid accumulations, it is advantageous if at least 95% of the volume of the cap space, preferably the entire cap space, is filled by the abutment.

The ring-shaped end section of the abutment can rest against the receptacle wall of the receptacle space.

The ring-shaped end section of the abutment can encompass at least some areas of the receptacle of the dental insert, in such a way that a radial widening of the opening width of the receptacle is prevented. Thus, the maximum opening width of the receptacle is limited by the encompassing the abutment.

The abutment, in particular the annular end section, may have at least one recess and/or one projection which, together with a corresponding projection and/or a corresponding recess of the insert, forms a positive connection to prevent twisting.

The annular end section may have gaps extending parallel to the longitudinal axis of the insert that interrupt the annular shape of the end section. This allows a certain flexibility to be achieved in the area of the end section.

A dental prosthesis according to the invention comprises an arrangement according to the invention and an implant, wherein the implant has a longitudinal axis A and wherein the implant is formed shell-shaped with a shell space at least in regions and has a projection, in particular a projection on the longitudinal axis, which extends into the shell space.

Preferably, the implant can also have an interface to a jawbone, e.g., in the form of a thread.

In contrast to screw connections, the interfaces of the dental prosthesis are preferably inseparably connected between the individual elements of the dental prosthesis, e.g., clamped, and in this preferred variant can only be separated from each other by a material-destroying intervention, e.g., drilling. This prevents unintentional loosening of the parts during the daily intended use of the dental prosthesis.

The dental prosthesis is preferably designed in such a way that the two aforementioned interfaces, i.e., the interface between the insert and the abutment and the interface between the insert and the implant, are located within the shell space of the implant. This creates a hygienic connection and minimizes the risk of inflammation spreading.

Ideally, the implant and the dental abutment should be spatially separated by the dental insert, so that there is no material contact between the implant and the dental abutment. This reduces friction between the two elements so that the insert also has a buffering effect in mechanical interaction.

### BRIEF DESCRIPTION OF THE DRAWING FIGURES

The invention is illustrated by the following figures. Individual features of the respective embodiment variants can also be implemented independently of concrete embodiment examples in other embodiment variants not shown.

The figures show as follows:

FIG. 1 shows a cross-section of a first variant of a dental insert according to the invention for a dental implant;

FIG. 2 shows a perspective representation of the insert of FIG. 1;

FIG. 3 shows a cross-section of an at least three-part dental prosthesis according to the invention which comprises an implant, an insertion cap and a dental abutment;

FIG. 4 shows a representation of the dental prosthesis of FIG. 3 with intersected implant;

FIG. 5 shows a schematic cross-section of a dental abutment with a mechanical connecting element;

FIG. 6a shows a schematically depicted cross-section of a first dental prosthesis according to the invention with the dental abutment of FIG. 5;

FIG. 6b shows a schematically represented cross-section of a second dental prosthesis according to the invention; and

FIG. 6c shows a schematically represented cross-section of a third prosthesis according to the invention.

### DETAILED DESCRIPTION

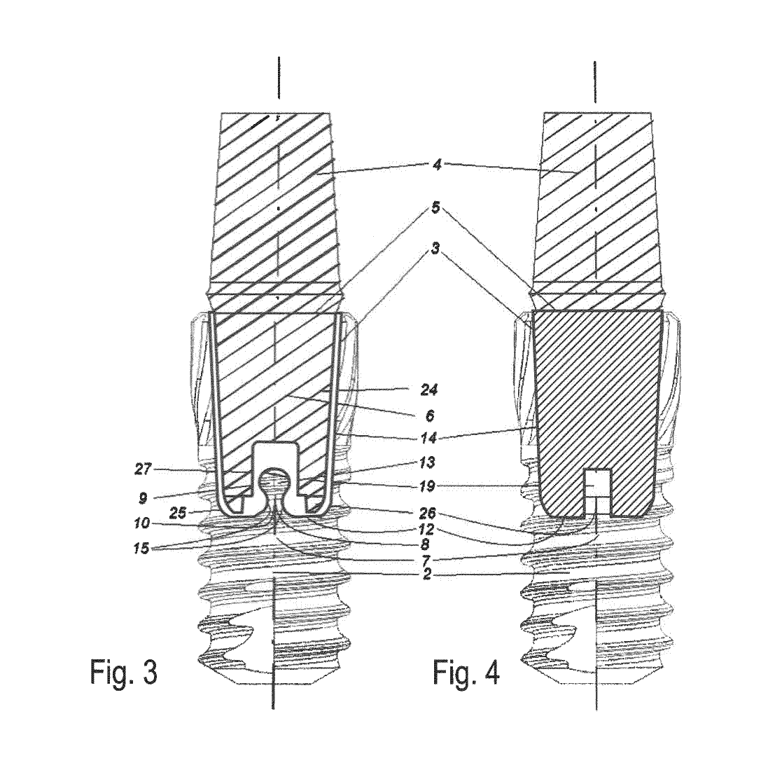

FIGS. 3 and 4 show a three-part configuration of a dental prosthesis 1 according to the invention. This comprises an implant 2, an insertion cap 3 according to the invention, as well as an abutment 4.

The implant 2 itself can be shell-shaped, at least in some areas, with a shell opening 5 and a shell space 6 to accommodate the insertion cap 3 and the abutment 4.

Implant 2 can also have a threaded area for connecting implant 2 and the entire dental prosthesis 1 to a jawbone.

An insertion cap 3 is arranged in positive connection on implant 2. The abutment 4 is attached to the insertion cap.

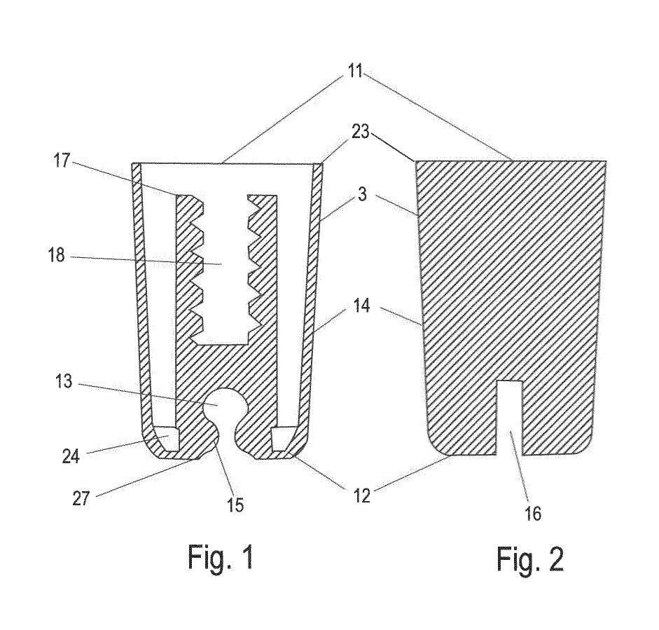

The shell-shaped implant 2 has a bottom area 7, in particular a closed bottom area, on which a projection 8 is arranged, which projects into the shell space 6. The projection has a projection thickening 9, for example a terminal projection head, and a projection shaft 10. The insertion cap 3 is attached to the projection 8, which is shown in detail in FIGS. 1 and 2.

The insertion cap 3 has a cap space 24 with a cap opening 11, having an opening plane, which is essentially parallel to the opening plane of the shell opening 5. The insertion cap also has a longitudinal axis A.

The insertion cap 3 has a cap base 12 with a sleeve-shaped receptacle 13 in which the projection 8 of the shell-shaped implant 2 can be arranged.

The sleeve-shaped receptacle has 13 edge projections 15, which project into a receptacle space formed by a receptacle wall 27 of receptacle 13.

In the assembled condition of the insertion cap 3, the edge projections 15 are arranged between the projection thickener 9 and the cap base 12 and prevent the displaceability R of the insertion cap 1 along the longitudinal axis A with respect to the shell-shaped implant 2.

The insertion cap 3 can essentially be divided into the end cap base 12 and a cap lateral surface 14. The cap lateral surface 14 essentially has the shape of the inner contour of an implant wall of implant 2 that delimits the shell space 6.

The insertion cap 3 has at least one gap-shaped recess 16, which extends along the cap base and in some areas along the cap lateral surface 14.

The gap-shaped recess 16 is a kind of material weakening of the insertion cap 3 in the area of the cap base 12 and enables the opening width of the sleeve-shaped receptacle 13 to be changed, so that the insertion cap 3 can be attached to and detached from the projection 8 without force or by overcoming only slight restoring forces caused by material deformation.

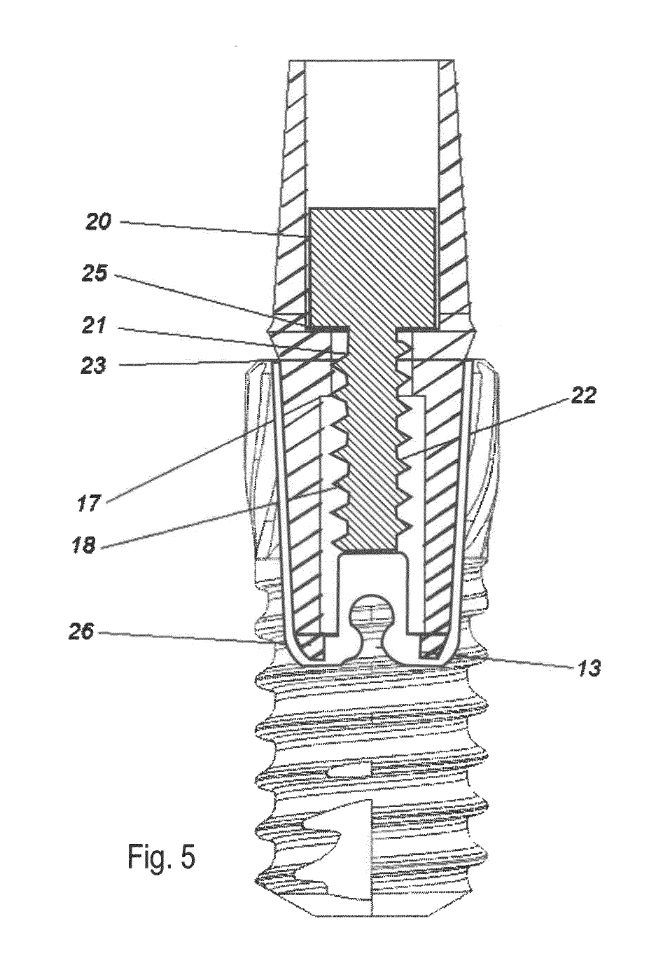

The insertion cap 3 has an interface 17 above, i.e., directed towards the cap opening 11, for connection with the abutment 4, as can be seen particularly clearly in FIG. 5. The receptacle 13′ is only schematically indicated. Interface 17 can preferably be designed as part of a guide channel, in particular as a screw channel 18. This can extend centered along the longitudinal axis A of the insertion cap 3.

Abutment 4 can be designed as a so-called abutment, i.e., an intermediate element between the artificial tooth crown and implant 2, or it can itself be designed as a tooth crown.

Abutment 4 is at least partially sleeve-shaped, wherein the guide channel extends as a screw channel 18 through the insertion cap and as a cylindrical cavity through the abutment 4 and runs along the longitudinal axis A. Within this guide channel, stop surfaces 25 are arranged for the stop of a screw head 20 of a mechanical connecting means 21, in particular a screw. The screw also has a thread 22, which engages in the screw channel 18 of interface 17.

Abutment 4 has a ring-shaped end area 26 made up of ring sections and interruptions which together define a ring.

The guide channel extends at its end over the outside of the sleeve-shaped receptacle 13 of the insertion cap 3 and rests against it in a force-locking manner. This results in a material reinforcement in the area of the receptacle 13 of the insertion cap 3 so that the opening width d can no longer be varied or can only be varied to a very limited extent.

Due to the interaction of the abutment 4 and the insertion cap 3, the insertion cap 3 is clamped or locked with the projection 8 of the implant. The abutment 4 serves as a latching element that achieves a fixation by positive locking between the insertion cap 3 and the implant. The abutment 4 in turn is connected to the insertion cap 3 by the mechanical connecting means. The abutment 4 can be detached from the insertion cap and the insertion cap 3 can be removed from the implant by loosening the connecting means.

Thus, the insertion cap can be exchanged. However, the mechanical connecting means only indirectly connects the abutment 4 to the implant 2 via the insertion cap.

The insertion cap thus serves as an exchangeable connection means between these two elements of the dental prosthesis and can be exchanged for hygienic reasons.

The insertion cap can be advantageously made of plastic and have an antimicrobial active substance, e.g., a silver compound.

The insertion cap also has an edge 23, which protrudes radially from the cap lateral surface and which delimits the cap opening. This edge 23 rests on the implant and at least partially covers an edge face of the implant.

At the end, the abutment 4 may also have one or more projections 19, recesses and/or depressions which, together with corresponding projections, depressions and/or recesses, e.g., the gap-shaped recess 16, form a positive connection in the insertion cap 3 to prevent the abutment 4 from twisting relative to the insertion cap 3.

The insertion cap 3 can preferably be made of a polyether ketone, in particular of a PEEK, PEKK and/or CF-PEEK.

Particularly preferably the insertion cap comprises an antibacterial and/or anti-inflammatory active ingredient.

The insertion cap 3 may also have a coupling point, e.g., a thread, for connecting to an insertion aid, through which the insertion sleeve can be inserted into the shell space 6 of implant 2 or removed from implant 2.

The mechanical fastening means for connecting the abutment 4 to the insertion cap 3 can be designed as a titanium or gold screw. Since the connection with implant 2 is made via the insertion cap 3, there is no risk of mechanical damage to the implant by the mechanical connecting means. As an alternative to a metallic screw, it is also possible to use a plastic screw made of CF-PEEK, for example. At the end, channel 18 can be closed by a plug which is not shown.

The implant 2 itself, but also the aforementioned mechanical connecting means, can also be made of zirconium, titanium and/or PEEK. It is also possible that both the implant 2 and/or the mechanical connecting means may be partially or completely made of a non-absorbable xerogenic or allogenic material, such as bovine bone.

Due to the special design of the multi-part dental prosthesis 1, there are no sharp edges that could generate tensions. The production of the respective individual elements can take place in industrially large numbers with comparatively high manufacturing tolerances. A special production of the insertion cap can be carried out by a so-called injection molding process.

Abutment 4 can be made of ceramic materials, zirconium oxide, glass material, metal-ceramic hydride materials, especially cermet materials and the like.

Alternatively, or additionally, the implant can also be made of a ceramic material.

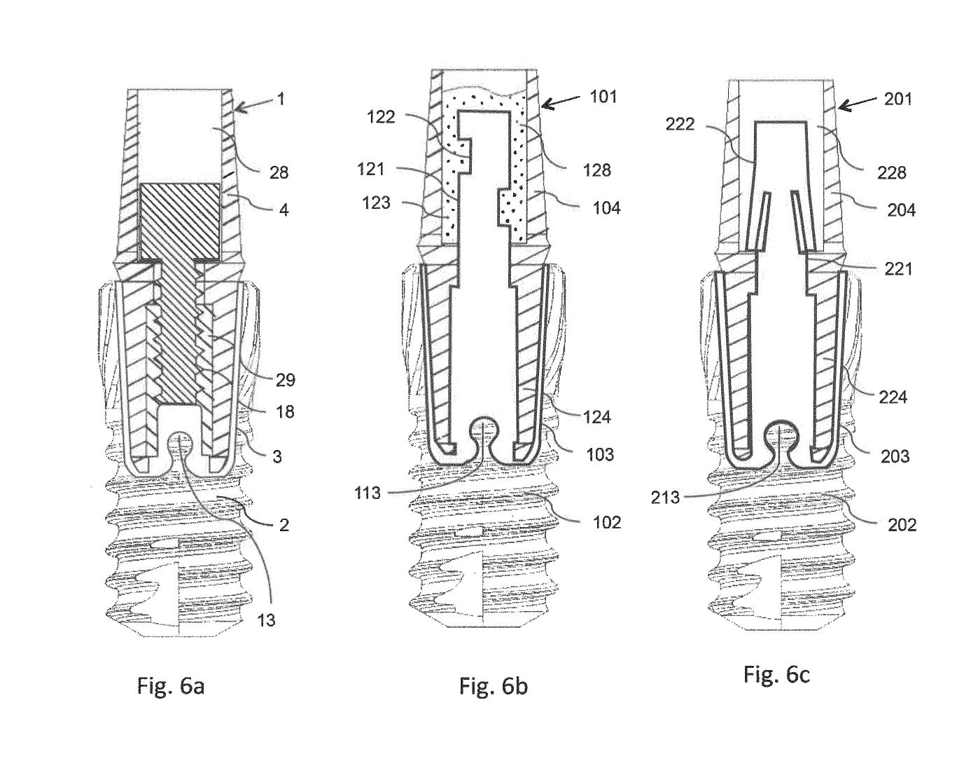

FIGS. 6a-6c show dental prosthesis variants 1, 101 and 201, which exemplify different embodiment variants that can be produced within the scope of the present invention. The variant of FIG. 6a has already been described before.

However, FIG. 6a shows that the screw channel 18 is arranged in a sleeve-shaped insertion element 29, which can be positively attached to the remaining insertion cap. In this embodiment variant, the insertion cap is therefore made in two parts. However, it is preferable if the insertion cap is designed in one piece in each embodiment variant, wherein instead of the insertion element, a projection with the corresponding screw channel 18 is monolithically formed with the remaining insertion cap.

The explanation of the design of the dental prosthesis variants of FIGS. 6b and 6c only discusses differences to the variant of FIG. 6a, which essentially consists of the different design of the second interface 17.

The dental prosthesis variant of FIG. 6b also features an implant 102, an insertion cap 103 as a dental insert according to the invention, and an abutment 104.

Instead of the screw connection, the insertion cap 103 has a pin-like projection 121 extending along the longitudinal axis A from the receptacle 113 into the cap space 124.

When the abutment 104 is inserted, the projection 121 extends into a guide channel 128 which, in this embodiment variant, is only formed in the abutment 104 and is limited at the edge by walls of the abutment 104.

The projection 121 may have terminal radial projections or recesses 122, for better anchoring of the projection 121 and thus also of the entire insertion cap 103 in a casting compound 123 introduced into the guide channel 128. The casting compound 123 may preferably be an adhesive or a curing compound, e.g., a cement or a curing polymer compound.

To replace the insertion cap 103, the guide channel 118 can be drilled out with a drilling instrument and then the abutment 104 and then also the insertion cap 103 can be removed.

In a preferred embodiment variant, the abutment consists at least in the area of the guide channel 118 of a harder material than the material of the insertion cap and the material of the hardened casting compound, so that drilling is carried out without damaging the material of the abutment and the reusability of the abutment 104 is made possible.

The dental prosthesis variant of FIG. 6c comprises an implant 202, an insertion cap 203 as a dental insert according to the invention, and an abutment 204.

The insertion cap 203 has a pin-like projection 221, which also projects along the longitudinal axis of the insertion cap starting from the receptacle 213 into the cap space 224 as shown in FIG. 6b. In comparison with FIG. 6b, the projection 221 of the insertion cap 204 has a latching element 222 at the end, which latches with a stop face 225 of a guide channel 228 of the abutment 204.

To replace the insertion cap 203, the guide channel 218 can be drilled out with a drilling instrument and then the abutment 204 and then also the insertion cap 203 can be removed.

Alternatively, the latching can also be released using a tool. For easier release of the latching, a predetermined breaking point can be provided in the area of the latching element.

In a preferred embodiment variant, the abutment consists of a harder material than the material of the insertion cap, at least in the area of the guide channel 218, in particular the material of the insertion cap in the area of the latching.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### REFERENCE NUMERALS

1 Dental prosthesis
2 Implant
3 Insertion cap
4 Abutment
5 Shell opening
6 Shell space
7 Bottom area
8 Projection
9 Projection thickening
10 Projection shaft
11 Cap opening
12 Cap base
13 Receptacle
14 Cap lateral surface
15 Projections
16 Gap-shaped recess
17 Interface
18 Screw channel
19 Projection
20 Screw head
21 Mechanical connecting means
22 Thread
23 Edge
24 Cap space
25 Stop surface
26 End section
27 Receptacle wall
28 Guide channel
29 Insertion element
101 Dental prosthesis
102 Implant
103 Insertion cap
104 Abutment
121 Projection
122 Recesses
123 Casting compound
128 Guide channel
201 Dental prosthesis
202 Implant
203 Insertion cap
204 Abutment
222 Latching element
225 Stop surface
228 Guide channel

1-17. (canceled)

18. A dental insert, for connecting a dental implant to a dental abutment, the dental insert comprising:
a first interface, in interaction with the dental abutment, configured to fix the dental insert to the implant by a latching and/or clamping connection; and
a second interface configured to fix the dental insert to the dental abutment,
wherein the dental insert is an insertion cap with a cap opening, a cap base, and a cap lateral surface,
wherein the cap base comprises, as the first interface, a receptacle with a receptacle space for introducing a projection of the implant.

19. The dental insert of claim 18, wherein the receptacle has a receptacle wall delimiting the receptacle space, wherein a cap space extends adjacent to the receptacle wall into which the dental abutment can be inserted in sections.

20. The dental insert of claim 18, wherein the insertion cap has a gap-shaped recess extending, at least in sections, over the cap base and at least in sections over the cap lateral surface.

21. The dental insert of claim 18, wherein the second interface is a screw channel or a pin-like projection.

22. The dental insert of claim 19, wherein the receptacle wall has projections that project into the receptacle space.

23. The dental insert of claim 18, wherein the dental insert comprises at least 45% by weight of a polyether ketone.

24. The dental insert of claim 18, wherein the dental insert is exchangeable by releasing a positive connection with the abutment, fixable in the implant, and a material of the dental insert comprises at least one antibacterial, disinfectant, or anti-inflammatory active substance.

25. The dental insert of claim 18, wherein the dental insert comprises a swellable material or consists of such a material which, when absorbing a liquid exhibits an increase in volume of at least 2% by volume.

26. An arrangement comprising:
a dental abutment; and
a dental insert for connecting a dental implant to the dental abutment, the dental insert comprising
a first interface, in interaction with the dental abutment, configured to fix the dental insert to the implant by a latching and/or clamping connection; and
a second interface configured to fix the dental insert to the dental abutment,
wherein the dental insert is an insertion cap with a cap opening, a cap base, and a cap lateral surface,
wherein the cap base comprises, as the first interface, a receptacle with a receptacle space for introducing a projection of the implant,
wherein the receptacle has a receptacle wall delimiting the receptacle space,
wherein a cap space extends adjacent to the receptacle wall,
wherein the dental abutment has an annular end section which is positionable in the cap space.

27. The arrangement of claim 26, wherein an entire volume of the cap space is filled by the abutment.

28. The arrangement of claim 26, wherein the annular end section of the abutment rests against the receptacle wall of the receptacle space.

29. The arrangement of claim 26, wherein the annular end section of the abutment at least partially engages around the receptacle in such a way as to prevent radial widening of an opening width of the receptacle.

30. The arrangement of claim 26, wherein the annular end section has at least one recess or one projection which, together with a corresponding projection or a corresponding recess of the dental insert, forms a positive connection to prevent rotation.

31. The arrangement of claim 26, wherein the annular end section has gaps extending parallel to a longitudinal axis of the insert and subdividing the annular end section into annular segments.

32. A dental prosthesis, comprising
a dental insert;
a dental abutment; and
a dental insert for connecting a dental implant to the dental abutment, the dental insert comprising
a first interface, in interaction with the dental abutment, configured to fix the dental insert to the implant by a latching and/or clamping connection; and
a second interface configured to fix the dental insert to the dental abutment,
wherein the dental insert is an insertion cap with a cap opening, a cap base, and a cap lateral surface,
wherein the cap base comprises, as the first interface, a receptacle with a receptacle space for introducing a projection of the implant,
wherein the receptacle has a receptacle wall delimiting the receptacle space,
wherein a cap space extends adjacent to the receptacle wall,
wherein the dental abutment has an annular end section which is positionable in the cap space,
wherein the dental insert has a longitudinal axis,
wherein the implant is formed at least in regions as a shell with a shell space and has a projection on the longitudinal axis that extends into the shell space.

33. The dental prosthesis of claim 32, wherein the first and second interfaces are arranged within the shell space of the implant.

34. The dental prosthesis of claim 32, wherein the implant and the dental abutment are spatially separated from each other by the dental insert such that there is no material contact between the implant and the dental abutment.
